(19) United States
(12) Patent Application Publication
(10) Pub. No.: US 2022/0347627 A1
(43) Pub. Date: Nov. 3, 2022

(54) RETROFIT CONTROL MODULE FOR REVERSE OSMOSIS SYSTEM AND METHOD FOR USING SAME

(71) Applicant: Les Equipements D'Erabliere C.D.L. Inc, Saint-Lazare (CA)

(72) Inventors: Marc-Andre CHABOT, Saint-Damien-de-Buckland (CA); Sylvain COTE, Saint-Lazare (CA)

(21) Appl. No.: 17/730,312

(22) Filed: Apr. 27, 2022

Related U.S. Application Data
(60) Provisional application No. 63/180,944, filed on Apr. 28, 2021.

(51) Int. Cl. B01D 61/12; B01D 61/02; B01D 61/08; C13B 20/16

(52) U.S. Cl. CPC B01D 61/12; B01D 61/025; B01D 61/08; C13B 20/16; H04W 84/12

(57) ABSTRACT

There is provided a retrofit control module that is connectable to various types of reverse osmosis systems, and a method of using the same. The retrofit control module includes a controller, the controller being located within a housing. The controller includes a first communication interface, the first communication interface being connectable to the reverse osmosis system, a processing unit and a memory connected to the processing unit. The processing unit is configured for receiving at least one parameter of the reverse osmosis system, comparing the at least one parameter of the reverse osmosis system with a predetermined threshold and in response to the at least one parameter of the reverse osmosis system being above the predetermined threshold: transmitting a control parameter to the reverse osmosis system, the control parameter causing the reverse osmosis system to control at least one component of the reverse osmosis system.

### CROSS REFERENCE

This application claims priority to U.S. Provisional Patent Application Ser. No. 63/180,944, filed Apr. 28, 2021, entitled “Retrofit Control Module for Reverse Osmosis System and Method for Using the Same”, the contents of which are incorporated herein by reference in their entirety.

### TECHNICAL FIELD

The present technology relates to a retrofit control module that is connectable to at least one reverse osmosis systems for controlling parameters thereof and to a method for using the same.

### BACKGROUND OF THE ART

The maple syrup industry, which has produced maple syrup in an artisanal way for a hundred years until the 1960s, has undergone transformation towards industrialization in order to initiate an increase in production performance, and to lower production costs which became prohibitive.

The classical way of harvesting sap was using buckets hanging from the trees. Thereafter, each bucket was to be emptied one by one into a large container, which was pulled by a horse, a tractor or another type of all-terrain vehicle into the sugar bush. Subsequently, the sap from the large container was sent to the sugar shack in order to be boiled using an evaporator to obtain a 66% brix sugar maple syrup. The main problem with the classical way of collecting maple sap was that maple growers were unable to expand their business due to the huge workload required to harvest sap from trees. As a result, profitability of maple syrup productions was almost impossible to reach.

In the 70s, an alternative method of collecting maple sap was developed. This alternative way involved collecting the sap from the maple trees using a tubing system, much the same way as in the dairy industry. This collection method was made possible thanks to spouts engaging notches of the trees and to a network of tubing and lines permanently installed on the entire sugar bush area and coupled to these spouts, where the sap of each of the maple trees is conveyed to a pumping station, which is then routed to the main sugar shack to be transformed into maple syrup. In many instances, the network of tubing is under vacuum. In other instances, the topography of the land allows the sap to descend by gravity to the pumping or harvesting station, thereby allowing the sap to be harvested in this way. Because they did not require a human presence as extensive as the classical bucket method, maple sap collection systems allowed maple producers to significantly expand their businesses and make them much more profitable.

In the early 1980s, manually operated osmosis systems were introduced in the maple sugaring industry. This system was already used in the maritime field in order to allow boats to produce their own drinking water using sea water. In the maple industry, however, the water kept is sugar water and not fresh water (filtra) unlike the maritime domain. The process is therefore named reverse osmosis system. Several reverse osmosis systems in the maple sugaring industry have been invented in order to optimize the performance and the clogging of membranes (filter) used to process the sweet sap.

Reverse osmosis systems have allowed maple syrup producers to expand by allowing them to process a much larger volume of sap without having to expand their evaporation system in order to produce the final product with a Brix of 66%. To date, reverse osmosis systems have the capacity to take a raw sap of 1% Brix and convert it to 35% Brix without resorting to an evaporative system. More and more reverse osmosis systems are installed in sap collection stations in order to greatly reduce the volumes and cost of transporting concentrated sap to the station with the evaporation system. Reverse osmosis systems have essentially become indispensable in the maple sugaring industry.

However, for the operator, a manual reverse osmosis system requires a lot of manual handling and adjustments as well as technical knowledge in order to optimize its operation. This constitutes a problem.

This is why, since the 2010s, automated reverse osmosis systems have been introduced in order to simplify the operation of the system and especially to be able to manage it remotely. Further, the concentration levels of reverse osmosis in the industry continue to increase, which requires much more monitoring of the system in order to prevent the premature clogging of the membranes. In summary, automatization of the reverse osmosis systems has become necessary to optimize productivity and profitability.

However, the industry currently requires the purchase of a new automated reverse osmosis system to benefit from such automatization. Indeed, for the moment, there is no device allowing for the automatization of the various manual reverse osmosis systems that are still used in the industry. This constitutes another problem, especially considering the cost of a new automated reverse osmosis system.

There is therefore a need for a retrofit control module for manual reverse osmosis systems, which would overcome at least one of the above-identified drawbacks.

### SUMMARY

In accordance with a broad aspect of the present technology, there is provided a retrofit control module comprising: a housing and a controller configurable to control a reverse osmosis system, the controller being located within the housing. The controller includes: a first communication interface, the first communication interface being connectable to the reverse osmosis system, a processing unit operatively connected to the first communication interface, and a non-transitory storage medium operatively connected to the processing unit, the non-transitory storage medium storing computer-readable instructions thereon. The processing unit, upon executing the computer-readable instructions, is configured for: receiving, via the first communication interface, at least one parameter of the reverse osmosis system, comparing the at least one parameter of the reverse osmosis system with a predetermined threshold, and in response to the comparing: transmitting a control parameter to the reverse osmosis system, the control parameter causing the reverse osmosis system to control at least one component of the reverse osmosis system.

In one or more embodiments of the retrofit control module, the at least one parameter of the reverse osmosis system comprises at least one of: a membrane pressure reading, a feed pressure reading, a permeate flowmeter reading, a tank level reading, a brix reading, a conductivity reading, a confirmation sensor reading, a temperature reading, and a pH reading.

In one or more embodiments of the retrofit control module, the at least one component of the reverse osmosis system comprises at least one of: a concentrate 3-way direction valve, a concentrate control valve, a concentrate sampling valve, a permeate 3-way direction valve, a pressure control valve, a motorized valve, and a membrane switch of the reverse osmosis system.

In one or more embodiments of the retrofit control module, the processing unit is further configured for determining a retention performance of a membrane of the reverse osmosis system based on the at least one parameter.

In one or more embodiments of the retrofit control module, the control signal is configured to cause the reverse osmosis system to: adjust concentrate, rinse membranes, soap wash membrane, acid wash membrane, sap control, permeate feed control, and continuous brix control.

In one or more embodiments of the retrofit control module, the processing unit of the controller is further configured for performing at least one of: brix monitoring, maple sap brix monitoring, permeate flow reading, pH monitoring and control, conductivity meter readings, preventive management, and high- and low-pressure protection.

In one or more embodiments of the retrofit control module, the first communication interface comprises at least one of a radiofrequency (RF) interface, a Wi-Fi™ interface, and a Bluetooth™ interface.

In one or more embodiments of the retrofit control module, the controller further comprises a second communication interface, the second communication interface is connectable to a mobile device.

In one or more embodiments of the retrofit control module, the controller is further configured for: transmitting the at least one parameter of the reverse osmosis system to the mobile device, and receiving the control parameter of the reverse osmosis system from the mobile device.

In one or more embodiments of the retrofit control module, the second communication interface comprises at least one of a radiofrequency (RF) interface, a Wi-Fi™ interface, and a Bluetooth™ interface.

In one or more embodiments of the retrofit control module, the controller further comprises a wired communication interface for operatively connecting the retrofit control module to the reverse osmosis system.

In one or more embodiments of the retrofit control module, the controller comprises an input/output interface, the input/output interface is operatively connectable to an input/output device includes at least one of: a screen, a touchscreen, a keyboard, a camera, and a speaker.

In accordance with a broad aspect of the present technology, there is provided a method for controlling a reverse osmosis system. The reverse osmosis system is operatively connected to a retrofit control module. The retrofit control module includes a controller, and the method is executed by a processing unit of the controller. The method comprises: receiving, from the reverse osmosis system, at least one parameter thereof, comparing the at least one parameter of the reverse osmosis system with a predetermined threshold, and in response to the comparing: transmitting a control parameter to the reverse osmosis system, the control parameter causing the reverse osmosis system to adjust at least one component.

In one or more embodiments of the method, the at least one parameter of the reverse osmosis system comprises at least one of: a membrane pressure reading, a feed pressure reading, a permeate flowmeter reading, a tank level reading, a brix reading, a conductivity reading, a confirmation sensor reading, a temperature reading, and a pH reading

In one or more embodiments of the method, the at least one component of the reverse comprises at least one of: a concentrate 3-way direction valve, a concentrate control valve, a concentrate sampling valve, a permeate 3-way direction valve, a pressure control valve, a motorized valve, and a membrane switch of the reverse osmosis system.

In one or more embodiments of the method, the method further comprises determining a retention performance of a membrane of the reverse osmosis system based on the at least one parameter.

In one or more embodiments of the method, the control signal is configured to cause the reverse osmosis system to perform at least one of: adjust concentrate, rinse membranes, soap wash membrane, acid wash membrane, sap control, permeate feed control, and continuous brix control.

In one or more embodiments of the method, the method further comprises performing at least one of: brix monitoring, maple sap brix monitoring, permeate flow reading, pH monitoring and control, conductivity meter readings, preventive management, and high- and low-pressure protection.

In one or more embodiments of the method, the controller is operatively connected to the reverse osmosis system via a first communication interface includes at least one of a radiofrequency (RF) interface, a Wi-Fi™ interface, and a Bluetooth™ interface.

In one or more embodiments of the method, the controller is operatively connected a mobile device via a second communication interface, and the method further comprises, prior to said transmitting the control parameter to the reverse osmosis system: transmitting the at least one parameter of the reverse osmosis system to the mobile device, and receiving the control parameter of the reverse osmosis system from the mobile device.

In one or more embodiments of the method, the second communication interface comprises at least one of a radiofrequency (RF) interface, a Wi-Fi™ interface, and a Bluetooth™ interface.

### BRIEF DESCRIPTION OF THE DRAWINGS

Having thus generally described the nature of the invention, reference will now be made to the accompanying drawings, showing by way of illustration example embodiments thereof and in which:

FIG. 1 depicts a schematic diagram of a retrofit control module for a reverse osmosis system in accordance with non-limiting embodiments of the present technology; and

FIG. 2 depicts a flow chart of a method of controlling a reverse osmosis system, the method being executed in accordance with non-limiting embodiments of the present technology.

### DETAILED DESCRIPTION

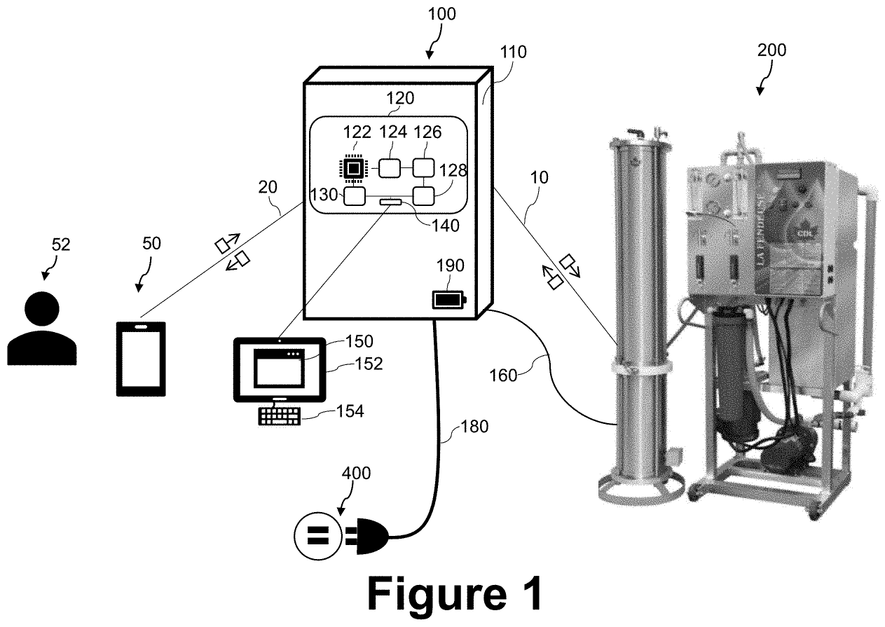

With reference to FIG. 1, there is described an embodiment of a retrofit control module 100 for a reverse osmosis system 200. In this embodiment, the retrofit control module 100 comprises: a housing 110, a controller 120 mounted in the housing 110 and configurable to control the reverse osmosis system 200. The controller 120 comprises at least one first communication for allowing communication between the controller 120 and the reverse osmosis system 200 via a first communication link 10, which may be a wireless communication interface 126 or a wired communication interface 128 via a wired communication link 160, as well as at least one second communication interface 130 for allowing the controller 120 to communicate with a mobile device 50 via a second communication link 20, as it will become apparent below. For powering the retrofit control module 100, an electrical plug 180 is provided, as well as an optional auxiliary power source taking the form of a battery 190.

According to one embodiment (illustrated in FIG. 1), the housing 110 has the general shape of a box. It will be appreciated that other shapes are possible. The housing 110 is preferably made of a liquid-proof material because it will generally be installed in the sap collection station next to the reverse osmosis system 200. It is contemplated that the housing 110 may be fixed to a wall, to a base of the reverse osmosis system 200, or to any other location in proximity to the reverse osmosis system 200.

The controller 120 is configured to transmit signals to and receive signals from the reverse osmosis system 200. The reverse osmosis system 200 may, for example, transmit or receive data related to one or more operating parameters to or from the controller 120 in analog or digital signals, as will be explained below.

In one embodiment, the controller 120 comprises a processing unit 122 and a non-transitory storage medium 124 operatively connected to the processing unit 122. The processing unit 122 includes a processing device or unit, such as, without limitation, an integrated circuit (IC), an application specific integrated circuit (ASIC), a microcomputer, a programmable logic controller (PLC), and/or any other programmable circuit. The processing unit 122 may include multiple processing units (e.g., in a multi-core configuration). The controller 120 is configurable to perform the operations described herein by programming processing unit 122. For example, processing unit 122 may be programmed by encoding an operation as one or more executable instructions and providing the executable instructions to processing unit 122 in storage medium 124 coupled to processing unit 122. Non-transitory storage medium 124 includes, without limitation, one or more random access memory (RAM) devices, one or more storage devices, and/or one or more computer readable media. Non-transitory storage medium 124 is configured to store data, such as computer-executable instructions. Non-transitory storage medium 124 includes any device allowing instructions, such as executable instructions and/or other data, to be stored and retrieved. It will be appreciated that one or more of the components of the controller 120 described herein may be part of an integrated circuit.

According to one embodiment (illustrated in FIG. 1), the controller 120 has at least one first communication interface 126 to communicate with the reverse osmosis system 200 via a first communication link 10. In one embodiment, the first communication interface 126 comprises a wireless communication interface such as one or more of: a radiofrequency (RF) interface, a Wi-Fi™ interface, a Bluetooth™ interface and the like. The at least one first communication interface 126 may be connectable to at least a portion of the components, subsystems and sensors of the reverse osmosis system 200 such as valves, motors, pressure sensors, etc. In another embodiment, the reverse osmosis system 200 may have a communication interface (not shown) operatively connected to its components, and the at least one first communication interface 126 may be connected to the communication interface of the reverse osmosis system 200.

According to one embodiment (illustrated in FIG. 1), the controller 120 has a wired communication interface 128 to communicate with the reverse osmosis system 200 via at least one wired communication link 160.

According to one embodiment (illustrated in FIG. 1), the controller 120 has at least one second communication interface 130 to communicate with a mobile device 50 via second communication link 20. The at least one second communication interface 130 comprises a wireless communication interface such as one or more of: a radiofrequency (RF) interface, a Wi-Fi™ interface, a Bluetooth™ interface and the like. The second communication interface 130 may be a wireless communication interface similar to the first communication interface 126 or may be a different type of wireless communication interface.

According to one embodiment (illustrated in FIG. 1), the mobile device 50 may comprise one or more of a laptop computer, a smartphone, a tablet, a personal digital assistant (PDA), and the like. The mobile device 50 is associated with a user 52 such as an operator of the reverse osmosis system 200 for example. The user 52 may access different parameters of the controller 120 and the reverse osmosis system 200 via the mobile device 50. It is contemplated that the mobile device 50 may be coupled to the controller 120 via a communication network (not shown) such as the Internet, which enables the user 52 to access information and/or control the controller 120 and the reverse osmosis system 200.

According to one embodiment (illustrated in FIG. 1), the controller 120 comprises at least one input/output interface 140 for coupling a plurality of components thereto. In one embodiment, the input/output interface 140 is coupled to a display 152 and an input device 154. The input/output interface 140 may be further be used to connect the controller 120 to other components such as storage mediums (e.g. external hard drives, USB keys), computing devices (e.g. computers, smartphones), additional input and output devices (e.g. mouse, cameras), sensors, switches, and the like.

In one embodiment, the input/output interface 140 is operatively connected to at least one display 152 for presenting information to the user 52. Display 152 is any component capable of conveying information to the user. Display 152 includes, without limitation, a display device (not shown) (e.g., a liquid crystal display (LCD), organic light emitting diode (OLED) display, or display 152 includes an output adapter (not shown), such as a video adapter and/or an audio adapter. Output adapter is operatively coupled to a processor (not depicted) and configured to be operatively coupled to an output device (not shown), such as a display device or an audio output device.

Moreover, input/output interface 140 is operatively connected to an input device 154 for receiving input from a user 52. Input device 154 includes, for example, a keyboard, a pointing device, a mouse, a stylus, a touch sensitive panel (e.g., a touch pad or a touch screen), a gyroscope, an accelerometer, a position detector, and/or an audio input device. A single component, such as a touch screen, may function as both an output device of display 152 and input device 154. The user 52 may, for example, program the controller 120 via the display 152 and the input device 154 to control different components of the reverse osmosis system 200.

The controller 120 is operatively connected, via the at least one first communication interface 126, to one or more components of the reverse osmosis system 200, such as one or more of: a concentrate 3-way direction valve; a concentrate control valve; a concentrate sampling valve; a permeate 3-way direction valve; a pressure control valve; a motorized valve; membrane switches; and sensors such as tank level sensors, pressure sensors, conductivity sensors, flow meters, flow switch sensors, brix sensors (e.g. optical sensor for measuring brix), confirmation sensors (e.g. limit switch), temperature sensors, pH sensors, and amperage sensors. The controller 120 may, for example, provide control signals to the one or more components and/or receive signals from the one or more components of the reverse osmosis system 200.

The retrofit control module 100 and controller 120 may have a plurality of interfaces or connectors for connecting the controller 120 to different types of reverse osmosis systems 200. It will be appreciated that the retrofit control module 100 and controller 120 may be connected using wired connection links (e.g., electric cables, fiber optic cables, etc.) and wireless connection links (radiofrequency, LTE, infrared (IR), Wi-Fi™, Bluetooth™, etc.). As a non-limiting example, the wired connection link may include a 37-pin connector cable and/or a universal serial bus (USB) cable. In one embodiment, the retrofit control module 100 and the controller 120 may be connected via a multistrand cable to one or more of a control panel, a terminal, and a junction box of the reverse osmosis system 200.

Additionally, the controller 120 may be configured to control one or more of the feed pump, booster pump, soap pump, acid pump, booster pump, membrane recirculation pump, high pressure pump, water and sap filters, solution filters, electric valves, sap tanks, soap tanks, washing solution tanks, wash tank, pump drain, turbine, and turbine motor of the reverse osmosis system 200.

In one embodiment, the controller 120 may, for example, provide control signals to the reverse osmosis system 200 to control one or more of: a feed pump, wash tank, a pump drain, a turbine, a turbine motor, adjust concentrate, rinse the membranes, membrane soap wash, membrane acid wash, control sap or permeate feed, and continuous brix control of the reverse osmosis system 200. It will be appreciated that the control signal may cause the reverse osmosis system 200 to activate, deactivate or adjust one or more operating parameters of a given component.

The controller 120 may, for example, provide the signals according to a predetermined schedule or upon receiving instructions to do so from the user 52 via the mobile device 50 and/or the display 152 and input device 154.

In one embodiment, the controller 120 may also receive different sensor readings from the reverse osmosis system 200 such as membrane pressure readings, feed pressure readings, permeate flowmeter readings, brix readings, conductivity readings, confirmation sensor readings, temperature readings, and pH readings. The controller 120 may, for example, provide the data to the display 152 for display to a user. Additionally or alternatively, the data may be transmitted to the mobile device 50 or other devices communicatively coupled to the controller 120.

In one embodiment, the controller 120 provides a graphical user interface (GUI) 150 which enables displaying parameters monitored by sensors of the reverse osmosis system 200 and/or control parameters of the reverse osmosis system 200.

In one embodiment, the controller 120 is configured to provide concentrate brix monitoring, maple sap brix monitoring, permeate flow reading, pH monitoring and control, conductivity meter readings, preventive management (plugging), and high- and low-pressure protection. In one embodiment, the controller 120 may receive data from the sensor(s) of the reverse osmosis system 200, store the data and perform statistical analysis of the sensor data. In one embodiment, the controller 120 is configured to perform monitoring of the above-mentioned parameters, compare the monitored parameters with average or reference values, and control one or more components of the reverse osmosis system 200 based on values of the monitored parameters. In one embodiment, by monitoring these parameters, performance of the membrane of in terms of retention may be assessed by the controller 120 to determine if operating conditions of the membrane meet the reference values provided by the manufacturer (e.g. pressure, temperature, and pH), which may enable optimizing the reverse osmosis system 200 and prevent premature wear of the membrane.

For example, the controller 120 may be preprogrammed to adjust parameters of the reverse osmosis system 200 based on threshold values and/or upon receiving commands to do so e.g. from the mobile device 50.

In one embodiment, the controller 120 is configured to provide a notification to the mobile device 50 and/or the display 152 when a parameter of the reverse osmosis system 200 is above a threshold or reference value. It should be understood that the controller 120 may instead provide a notification when the parameter is below the threshold or reference value. For example, the notification may include at least one a visual indication on a screen, a sound, a vibration or the like, which may alert the user 304 that the parameter is above the threshold or that there is an issue with a component of the reverse osmosis system 200.

In one embodiment, components of a reverse osmosis system 200 that are controllable by the controller 120 may vary depending on the brand and model of the reverse osmosis system 200. It is contemplated that the controller 120 may store, in the storage medium 124, configuration parameters associated with different brands and models of reverse osmosis systems, which may be selected by the user 52 via the mobile device 50 and/or the display 152 and input device 154 after connecting the controller 120 to a given reverse osmosis system 200.

In one embodiment, depending on the user and associated mobile device, different type of access rights may be granted. For example, a first given user may only receive sensor readings and operating parameters of the reverse osmosis system 200 via the controller 120, without having the right to control or modify the parameters of the reverse osmosis system 200, whereas another given user associated with another mobile device may have the right to control the parameters of the reverse osmosis system 200.

It will be appreciated that the combination of the input/output interface 140, the first communication interface 126 and the wired communication interface 128 enables connecting the retrofit control module 100 to different types and models of reverse osmosis systems available on the market.

According to one embodiment (illustrated in FIG. 1), the power source of the retrofit control module 100 is an electrical wired plug 180 connectable to an electrical socket 400 of the sap collection station.

According to one embodiment (illustrated in FIG. 1), the retrofit control module 100 also comprises a power source such as a battery 190 to allow for the operation of the system.

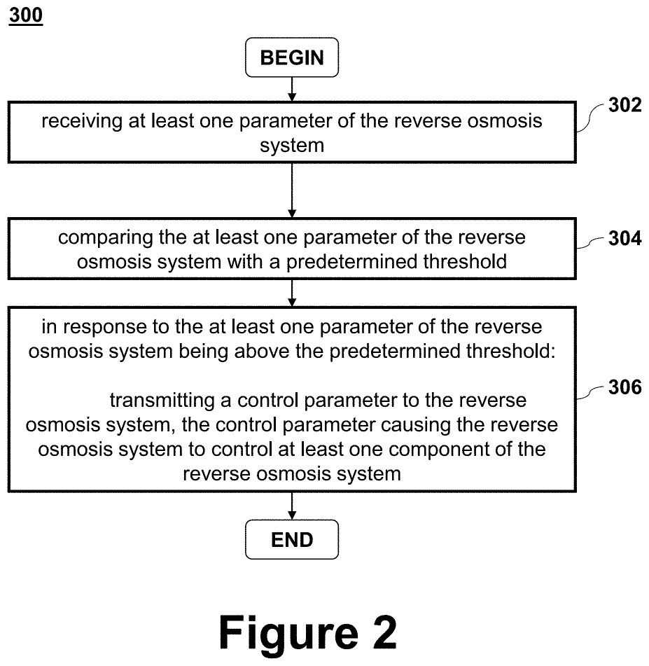

With reference to FIG. 2, a method 300 of controlling the reverse osmosis system 200 will now be described

The method 300 may be executed by the mobile device 50 and/or the controller 120 of the retrofit control module 100.

The retrofit control module 100 is operatively connected to the reverse osmosis system 200 using at least one of a wired communication link 160 and a first wireless communication link 10.

In one or more embodiments, the controller 120 comprises a processing unit 122 and a non-transitory storage medium 124 operatively connected to the processing unit 122. The non-transitory storage medium 124 stores computer-readable instructions. The processing unit 122, upon executing the computer-readable instructions, is configured or is operable to execute method 300.

According to step 302, at least one parameter of the reverse osmosis system 200 is received. The at least one parameter of the reverse osmosis system 200 comprises at least one of: a membrane pressure reading, a feed pressure reading, a permeate flowmeter reading, a tank level reading, a temperature reading, and a pH reading.

According to step 304, the at least one parameter of the reverse osmosis system 200 is compared with a predetermined threshold.

According to step 306, in response to the at least one parameter of the reverse osmosis system being above the predetermined threshold, a control parameter is transmitted to the reverse osmosis system 200, the control parameter causing the reverse osmosis system 200 to control at least one component of the reverse osmosis system 200.

In one or more embodiments, the at least one component of the reverse osmosis system 200 comprises at least one of: a concentrate 3-way direction valve, a concentrate control valve, a concentrate sampling valve, a permeate 3-way direction valve, a pressure control valve, a motorized valve, and a membrane switch of the reverse osmosis system.

In one or more embodiments, the control parameter causes the reverse osmosis system 200 to perform at least one of: adjust concentrate, rinse membranes, soap wash membrane, acid wash membrane, sap control, permeate feed control, and continuous brix control.

In one or more embodiments, the controller 120 is configured to perform brix monitoring, maple sap brix monitoring, permeate flow reading, pH monitoring and control, conductivity meter readings, preventive management, and high- and low-pressure protection.

The one or more embodiments described above are intended to be exemplary only.

1. A retrofit control module comprising:
a housing;
a controller configurable to control a reverse osmosis system, the controller being located within the housing, the controller comprising:
a first communication interface, the first communication interface being connectable to the reverse osmosis system;
a processing unit operatively connected to the first communication interface; and
a non-transitory storage medium operatively connected to the processing unit, the non-transitory storage medium storing computer-readable instructions thereon;
the processing unit, upon executing the computer-readable instructions, being configured for:
receiving, via the first communication interface, at least one parameter of the reverse osmosis system;
comparing the at least one parameter of the reverse osmosis system with a predetermined threshold; and
in response to the comparing:
transmitting a control parameter to the reverse osmosis system, the control parameter causing the reverse osmosis system to control at least one component of the reverse osmosis system.

2. The retrofit control module of claim 1, wherein the at least one parameter of the reverse osmosis system comprises at least one of: a membrane pressure reading, a feed pressure reading, a permeate flowmeter reading, a tank level reading, a brix reading, a conductivity reading, a confirmation sensor reading, a temperature reading, and a pH reading.

3. The retrofit control module of claim 1, wherein the at least one component of the reverse osmosis system comprises at least one of: a concentrate 3-way direction valve, a concentrate control valve, a concentrate sampling valve, a permeate 3-way direction valve, a pressure control valve, a motorized valve, and a membrane switch of the reverse osmosis system.

4. The retrofit control module of claim 1, wherein the processing unit is further configured for determining a retention performance of a membrane of the reverse osmosis system based on the at least one parameter.

5. The retrofit control module of claim 1, wherein the control signal is configured to cause the reverse osmosis system to: adjust concentrate, rinse membranes, soap wash membrane, acid wash membrane, sap control, permeate feed control, and continuous brix control.

6. The retrofit control module of claim 1, wherein the processing unit of the controller is further configured for performing at least one of: brix monitoring, maple sap brix monitoring, permeate flow reading, pH monitoring and control, conductivity meter readings, preventive management, and high and low pressure protection.

7. The retrofit control module of claim 1, wherein the first communication interface comprises at least one of a radiofrequency (RF) interface, a Wi-Fi™ interface, and a Bluetooth™ interface.

8. The retrofit control module of claim 1, wherein the controller further comprises a second communication interface, the second communication interface being connectable to a mobile device.

9. The retrofit control module of claim 8, wherein the controller is further configured for:
transmitting the at least one parameter of the reverse osmosis system to the mobile device; and
receiving the control parameter of the reverse osmosis system from the mobile device.

10. The retrofit control module of claim 8, wherein the second communication interface comprises at least one of a radio frequency (RF) interface, a Wi-Fi™ interface, and a Bluetooth™ interface.

11. The retrofit control module of claim 1, wherein the controller further comprises a wired communication interface for operatively connecting the retrofit control module to the reverse osmosis system.

12. The retrofit control module of claim 1, wherein the controller comprises an input/output interface, the input/output interface being operatively connectable to an input/output device comprising at least one of: a screen, a touchscreen, a keyboard, a camera, and a speaker.

13. A method for controlling a reverse osmosis system, the reverse osmosis system being operatively connected to a retrofit control module comprising a controller, the method being executed by a processing unit of the controller, the method comprising:
receiving, from the reverse osmosis system, at least one parameter thereof;
comparing the at least one parameter of the reverse osmosis system with a predetermined threshold; and
in response to the comparing:
transmitting a control parameter to the reverse osmosis system, the control parameter causing the reverse osmosis system to adjust at least one component.

14. The method of claim 13, wherein the at least one parameter of the reverse osmosis system comprises at least one of: a membrane pressure reading, a feed pressure reading, a permeate flowmeter reading, a tank level reading, a brix reading, a conductivity reading, a confirmation sensor reading, a temperature reading, and a pH reading.

15. The method of claim 13, wherein the at least one component of the reverse comprises at least one of: a concentrate 3-way direction valve, a concentrate control valve, a concentrate sampling valve, a permeate 3-way direction valve, a pressure control valve, a motorized valve, and a membrane switch of the reverse osmosis system.

16. The method of claim 13, further comprising determining a retention performance of a membrane of the reverse osmosis system based on the at least one parameter.

17. The method of claim 13, wherein the control signal is configured to cause the reverse osmosis system to perform at least one of: adjust concentrate, rinse membranes, soap wash membrane, acid wash membrane, sap control, permeate feed control, and continuous brix control.

18. The method of claim 13, further comprising performing at least one of: brix monitoring, maple sap brix monitoring, permeate flow reading, pH monitoring and control, conductivity meter readings, preventive management, and high and low pressure protection.

19. The method of claim 13, wherein the controller is operatively connected to the reverse osmosis system via a first communication interface comprising at least one of a radiofrequency (RF) interface, a Wi-Fi™ interface, and a Bluetooth™ interface.

20. The method of claim 13, wherein the controller is operatively connected a mobile device via a second communication interface; and wherein the method further comprises, prior to said transmitting the control parameter to the reverse osmosis system:
transmitting the at least one parameter of the reverse osmosis system to the mobile device; and
receiving the control parameter of the reverse osmosis system from the mobile device.
